(19) United States
(12) Patent Application Publication
(10) Pub. No.: US 2026/0269876 A1
(43) Pub. Date: Sep. 10, 2026

(54) RECONFIGURABLE INTELLIGENT SURFACE (RIS) SPLIT RATIO FEEDBACK FOR MULTI-TRANSMISSION RECEPTION POINT (MTRP) TRANSMISSIONS VIA A SHARED RIS

(71) Applicant: QUALCOMM Incorporated, San Diego, CA (US)

(72) Inventors: Min HUANG, Beijing (CN); Mingxi YIN, Beijing (CN); Hao XU, Beijing (CN); Jing DAI, Beijing (CN)

(21) Appl. No.: 19/163,806

(22) PCT Filed: Apr. 23, 2023
(86) PCT No.: PCT/CN2023/090010

§ 371 Date: Sep. 9, 2025

(51) Int. Cl. H04B 7/04; H04L 5/00

(52) U.S. Cl. CPC H04B 7/04013; H04L 5/0051

(57) ABSTRACT

A method for wireless communication includes receiving, from a first network node of a group of network nodes, a first message configuring a group of channel state information (CSI) reference signals (RSS) (CSI-RSs). Each CSI-RS may be associated with a reconfigurable intelligent surface (RIS)-based channel of a group of RIS-based channels, where each RIS-based channel may be associated with a respective communication link between a respective network node and the UE via a RIS. The method also includes receiving, from each network node, via the RIS, the respective CSI-RS. The method further includes estimating, for each RIS-based channel, one or more respective channel conditions in accordance with measuring the respective CSI-RS of the group of CSI-RS. The method also includes transmitting, to the first network node, a second message indicating a RIS allocation ratio associated with the estimated one or more respective channel conditions associated with each RIS-based channel.

### FIELD OF THE DISCLOSURE

The present disclosure relates generally to wireless communications, and more specifically to a reconfigurable intelligent surface (RIS) split ratio for multi-transmission reception point (mTRP) transmissions via a shared RIS.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (for example, bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmission reception point (TRP), a new radio (NR) BS, a 5G Node B, a 6G network node, and/or the like.

The above multiple access technologies have been adopted in various telecommunications standards to provide a common protocol that enables different UEs to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (for example, also known as discrete Fourier transform spread OFDM (DFT-s-OFDM)) on the uplink (UL), as well as supporting beamforming, multiple-input multiple-output (MIMO) antenna technology, and carrier aggregation.

In some wireless networks, passive multiple-input multiple-output (MIMO) antenna units may be used in place of one or more active antenna units. A reconfigurable intelligent surface (RIS) is an example of a passive MIMO antenna unit. The RIS may include densely-placed reconfigurable meta-elements controlled by one or more wireless devices, such as one or more network nodes, to reflect or refract wireless signals in a target direction. As a result, the RIS may extend coverage of a wireless network with little impact on the total power consumption of a wireless system associated with the wireless network. In some examples, two or more network nodes may share a single RIS to communicate with a single UE in a multi-transmission reception point (mTRP) system. In other examples, a single RIS may be shared among two or more network nodes to communicate with respective UEs.

### SUMMARY

In one aspect of the present disclosure, a method for wireless communication by a UE is disclosed. The method includes receiving, from a first network node of a group of network nodes, a first message configuring a group of channel state information (CSI) reference signals (RSS) (CSI-RSs). Each CSI-RS of the group of CSI-RSs may associated with a reconfigurable intelligent surface (RIS)-based channel of a group of RIS-based channels. Each RIS-based channel, of the group of RIS-based channels, may be associated with a respective communication link between a respective network node, of the group of network nodes, and the UE via a RIS. The method also includes receiving, from each network node of the group of network nodes, via the RIS, the respective CSI-RS of the group of CSI-RSs. The method further includes estimating, for each RIS-based channel of the group of RIS-based channels, one or more respective channel conditions in accordance with measuring the respective CSI-RS of the group of CSI-RS. The method still further includes transmitting, to the first network node, a second message indicating a RIS allocation ratio associated with the estimated one or more respective channel conditions associated with each RIS-based channel of the group of RIS-based channels.

Another aspect of the present disclosure is directed to an apparatus including means for receiving, from a first network node of a group of network nodes, a first message configuring a group of CSI-RSs. Each CSI-RS of the group of CSI-RSs may associated with a RIS-based channel of a group of RIS-based channels. Each RIS-based channel, of the group of RIS-based channels, may be associated with a respective communication link between a respective network node, of the group of network nodes, and the UE via a RIS. The apparatus also includes means for receiving, from each network node of the group of network nodes, via the RIS, the respective CSI-RS of the group of CSI-RSs. The apparatus further includes means for estimating, for each RIS-based channel of the group of RIS-based channels, one or more respective channel conditions in accordance with measuring the respective CSI-RS of the group of CSI-RS. The apparatus still further includes means for transmitting, to the first network node, a second message indicating a RIS allocation ratio associated with the estimated one or more respective channel conditions associated with each RIS-based channel of the group of RIS-based channels.

In another aspect of the present disclosure, a non-transitory computer-readable medium with non-transitory program code recorded thereon is disclosed. The program code is for wireless communication at a UE. The program code is executed by a processor and includes program code to receive, from a first network node of a group of network nodes, a first message configuring a group of CSI-RSs. Each CSI-RS of the group of CSI-RSs may associated with a RIS-based channel of a group of RIS-based channels. Each RIS-based channel, of the group of RIS-based channels, may be associated with a respective communication link between a respective network node, of the group of network nodes, and the UE via a RIS. The program code also includes program code to receive, from each network node of the group of network nodes, via the RIS, the respective CSI-RS of the group of CSI-RSs. The program code further includes program code to estimate, for each RIS-based channel of the group of RIS-based channels, one or more respective channel conditions in accordance with measuring the respective CSI-RS of the group of CSI-RS. The program code still further includes program code to transmit, to the first network node, a second message indicating a RIS allocation ratio associated with the estimated one or more respective channel conditions associated with each RIS-based channel of the group of RIS-based channels.

Another aspect of the present disclosure is directed to an apparatus. The apparatus having a memory, one or more processors coupled to the memory, and instructions stored in the memory. The instructions being operable, when executed by the processor, to cause the apparatus to receive, from a first network node of a group of network nodes, a first message configuring a group of CSI-RSs. Each CSI-RS of the group of CSI-RSs may associated with a RIS-based channel of a group of RIS-based channels. Each RIS-based channel, of the group of RIS-based channels, may be associated with a respective communication link between a respective network node, of the group of network nodes, and the UE via a RIS. Execution of the instructions also cause the apparatus to receive, from each network node of the group of network nodes, via the RIS, the respective CSI-RS of the group of CSI-RSs. Execution of the instructions additionally cause the apparatus to estimate, for each RIS-based channel of the group of RIS-based channels, one or more respective channel conditions in accordance with measuring the respective CSI-RS of the group of CSI-RS. Execution of the instructions further cause the apparatus to transmit, to the first network node, a second message indicating a RIS allocation ratio associated with the estimated one or more respective channel conditions associated with each RIS-based channel of the group of RIS-based channels.

In one aspect of the present disclosure, a method for wireless communication at a network node is disclosed. The method includes transmitting a first message configuring a group of CSI-RSs at UE, each CSI-RS of the group of CSI-RSs being associated with a RIS-based channel of a group of RIS-based channels. The method also includes transmitting a second message configuring the group of CSI-RSs and corresponding incident beams at the RIS. The method further includes transmitting the respective CSI-RS of the group of CSI-RSs. The method still further includes receiving, from the UE in accordance with transmitting the respective CSI-RS, a third message indicating a RIS allocation ratio associated with one or more respective channel conditions associated with each RIS-based channel of the group of RIS-based channels. The method also includes transmitting a fourth message configuring the RIS in accordance with the RIS allocation ratio.

Another aspect of the present disclosure is directed to an apparatus including means for transmitting a first message configuring a group of CSI-RSs at UE, each CSI-RS of the group of CSI-RSs being associated with a RIS-based channel of a group of RIS-based channels. The apparatus also includes means for transmitting a second message configuring the group of CSI-RSs and corresponding incident beams at the RIS. The apparatus further includes means for transmitting the respective CSI-RS of the group of CSI-RSs. The apparatus still further includes means for receiving, from the UE in accordance with transmitting the respective CSI-RS, a third message indicating a RIS allocation ratio associated with one or more respective channel conditions associated with each RIS-based channel of the group of RIS-based channels. The apparatus also includes means for transmitting a fourth message configuring the RIS in accordance with the RIS allocation ratio.

In another aspect of the present disclosure, a non-transitory computer-readable medium with non-transitory program code recorded thereon is disclosed. The program code is for wireless communication at a network node. The program code is executed by a processor and includes program code to transmit a first message configuring a group of CSI-RSs at UE, each CSI-RS of the group of CSI-RSs being associated with a RIS-based channel of a group of RIS-based channels. The program code also includes program code to transmit a second message configuring the group of CSI-RSs and corresponding incident beams at the RIS. The program code further includes program code to transmit the respective CSI-RS of the group of CSI-RSs. The program code still further includes program code to xxxx. The program code also includes program code to receive, from the UE in accordance with transmitting the respective CSI-RS, a third message indicating a RIS allocation ratio associated with one or more respective channel conditions associated with each RIS-based channel of the group of RIS-based channels. The program code further includes program code to transmit a fourth message configuring the RIS in accordance with the RIS allocation ratio.

Another aspect of the present disclosure is directed to an apparatus. The apparatus having a memory, one or more processors coupled to the memory, and instructions stored in the memory. The instructions being operable, when executed by the processor, to cause the apparatus to transmit a first message configuring a group of CSI-RSs at UE, each CSI-RS of the group of CSI-RSs being associated with a RIS-based channel of a group of RIS-based channels. Execution of the instructions also cause the apparatus to transmit a second message configuring the group of CSI-RSs and corresponding incident beams at the RIS. Execution of the instructions additionally cause the apparatus to transmit the respective CSI-RS of the group of CSI-RSs. Execution of the instructions further cause the apparatus to receive, from the UE in accordance with transmitting the respective CSI-RS, a third message indicating a RIS allocation ratio associated with one or more respective channel conditions associated with each RIS-based channel of the group of RIS-based channels. Execution of the instructions still cause the apparatus to transmit a fourth message configuring the RIS in accordance with the RIS allocation ratio.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communications network, in accordance with various aspects of the present disclosure.

FIG. 2 is a block diagram conceptually illustrating an example of a base station in communication with a user equipment (UE) in a wireless communications network, in accordance with various aspects of the present disclosure.

FIG. 3 is a block diagram illustrating an example disaggregated base station architecture, in accordance with various aspects of the present disclosure.

FIG. 4A is a block diagram illustrating a wireless communication network employing a reconfigurable intelligent surface (RIS) to extend network coverage.

FIG. 4B is a block diagram illustrating an example of multiple transmission reception points (TRPs) sharing a RIS to reflect respective signals to a single UE.

FIG. 4C is a block diagram illustrating an example of multiple TRPs sharing a RIS to reflect respective signals to a group of UE.

FIG. 5 is a timing diagram illustrating an example of a UE determining a RIS allocation ratio, in accordance with various aspects of the present disclosure.

FIG. 6 is a block diagram illustrating an example wireless communication device that supports estimating a RIS allocation ratio, in accordance with some aspects of the present disclosure

FIG. 7 is a flow diagram illustrating an example process for estimating a RIS allocation ratio, performed, for example, by a UE, in accordance with various aspects of the present disclosure.

FIG. 8 is a block diagram illustrating an example wireless communication device that supports configuring a RIS in accordance with a RIS allocation ratio estimated at a UE, in accordance with various aspects of the present disclosure.

FIG. 9 is a flow diagram illustrating an example process for configuring a RIS in accordance with a RIS allocation ratio estimated at a UE, performed by a network node, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G, 4G, and/or 6G technologies.

In some wireless communication systems, one or more network nodes may control a reconfigurable intelligent surface (RIS) to reflect or refract wireless signals in a target direction, such as toward one or more UEs, using meta-elements of or incorporated with the RIS. Each meta-element may be associated with an adjustment to one or both of a phase or amplitude of a received wireless signal. In a multi-transmission reception point (mTRP) deployment, a single RIS may be shared among a group of TRPs (which may hereinafter be referred to generally as network nodes) to communicate simultaneously with a single UE. To account for different incident directions (directions at which respective wireless signals from respective TRPs arrive at the RIS), different subsets of the meta-elements of the RIS may be allocated to respective network nodes in accordance with a RIS allocation ratio (which may also be referred to generally as a RIS split ratio). The RIS allocation ratio defines a number of meta-elements, from a total number of meta-elements, allocated to respective network nodes. The RIS allocation ratio may be represented as a set of fractions, in which each fraction, of the set of fractions, corresponds to a respective node. For example, the RIS allocation ratio may be [1/3, 2/3] for a set of network nodes. In this example, a first network node, of the set of network nodes, may be allocated one-third of the total number of the meta-elements of the RIS and a second network node, of the set of network nodes, may be allocated two-thirds of the total number of the meta-elements of the RIS. The RIS allocation ratio may impact the channel capacities associated with a group of RIS-based channels respectively associated with a group of communication links respectively associated with the group of network nodes. Each RIS-based channel is an example of a wireless communication channel between a respective network node and the UE, where signals transmitted by the network node via the RIS-based channel are reflected or refracted by the RIS to the UE, or vice versa. In some examples, allocating more meta-elements to a certain network node, of the group of network nodes, may improve a beamforming gain and link quality associated with the corresponding RIS-based channel, at the expense of reducing respective link qualities of other RIS-based channels of the group of RIS-based channels.

Various aspects of the present disclosure are directed to determining, by a UE, a more accurate or optimal RIS allocation ratio that increases or maximizes the total channel capacity of a group of RIS-based channels associated with respective communication links between a single UE and respective transmission reception points (TRPs) of a multiple TRP (mTRP) system. For example, a UE may receive a first message, from a first network node (such as a first TRP) of a group of network nodes (a group of TRPs of an mTRP system), configuring a group of channel state information (CSI) reference signals (RSS) (CSI-RSs). Each CSI-RS of the group of CSI-RSs may be associated with a respective RIS-based channel of a group of RIS-based channels respectively associated with the group of network nodes. Subsequently, the UE receives, from each of the network nodes, the respective CSI-RS via a reflection or refraction from the RIS. The group of CSI-RSs may be received, at the RIS, at different times. Prior to allocating different subsets of meta-elements of the RIS to respective network nodes in accordance with a RIS allocation ratio, the RIS may reflect or refract each of the CSI-RSs via the entire surface of the RIS. The UE then estimates one or more respective channel conditions for each of the RIS-based channels in accordance with measuring the respective CSI-RS. For each RIS-based channel, the UE estimates a respective channel capacity in accordance with the one or more respective channel conditions and various RIS allocation ratios. In some examples, the UE then determines the RIS allocation ratio that maximizes or increases a total channel capacity, which is a collective sum of respective channel capacities of the group of RIS-based channels. Lastly, the UE transmits a second message to the first network node indicating the RIS allocation ratio.

Particular aspects of the subject matter described in this disclosure can be implemented to realize one or more of the following potential advantages. In some examples, because a UE may be capable of more accurately estimating channel conditions in accordance with measuring channel state information (CSI) reference signals (RSs) (CSI-RSs) as compared with a network node, the UE may be better suited to determine an optimal RIS allocation ratio by utilizing, at the UE, estimates of one or more respective channel conditions associated with each RIS-based channel of a group of RIS-based channels. As such, determining the RIS allocation ratio at the UE may increase an accuracy of the RIS allocation ratio, which may then be utilized to increase or maximize the total channel capacity of the group of RIS-based channels. Increasing the total channel capacity of the group of RIS-based channels may increase the throughput associated with the RIS, while also reducing latency.

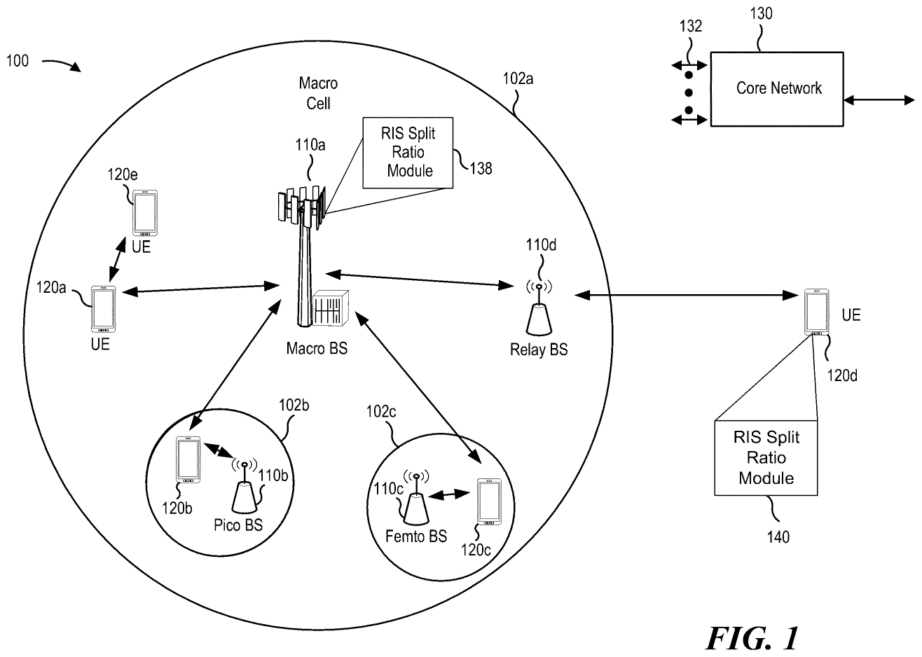

FIG. 1 is a diagram illustrating a network 100 in which aspects of the present disclosure may be practiced. The network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmission reception point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (for example, three) cells. The terms “eNB,” “base station,” “NR BS,” “gNB,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (for example, a BS or a UE) and send a transmission of the data to a downstream station (for example, a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (for example, macro BSs, pico BSs, femto BSs, relay BSs, and/or the like). These different types of BSs may have different transmit power levels, different coverage areas, and different impact on interference in the wireless network 100. For example, macro BSs may have a high transmit power level (for example, 5 to 40 watts) whereas pico BSs, femto BSs, and relay BSs may have lower transmit power levels (for example, 0.1 to 2 watts).

As an example, the BSs 110 (shown as BS 110a, BS 110b, BS 110c, and BS 110d) and the core network 130 may exchange communications via backhaul links 132 (for example, S1, etc.). Base stations 110 may communicate with one another over other backhaul links (for example, X2, etc.) either directly or indirectly (for example, through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (for example, S1, S2, etc.) and may perform radio configuration and scheduling for communications with the UEs 120. In some configurations, various functions of each access network entity or base station 110 may be distributed across various network devices (for example, radio heads and access network controllers) or consolidated into a single network device (for example, a base station 110).

UEs 120 (for example, 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (for example, smart ring, smart bracelet)), an entertainment device (for example, a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

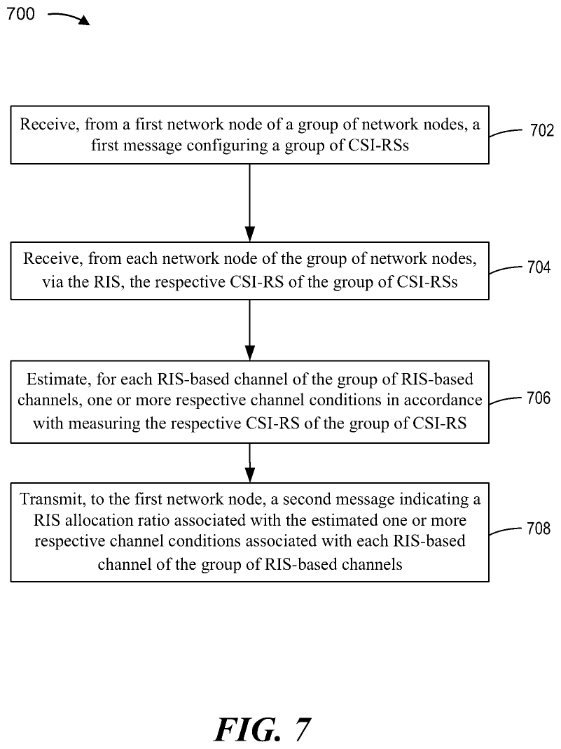

The UEs 120 may include a RIS split module 140. For brevity, only one UE 120d is shown as including the RIS split module 140. The RIS split module 140 may perform various operations, including operations of the process 700 described below with reference to FIG. 7.

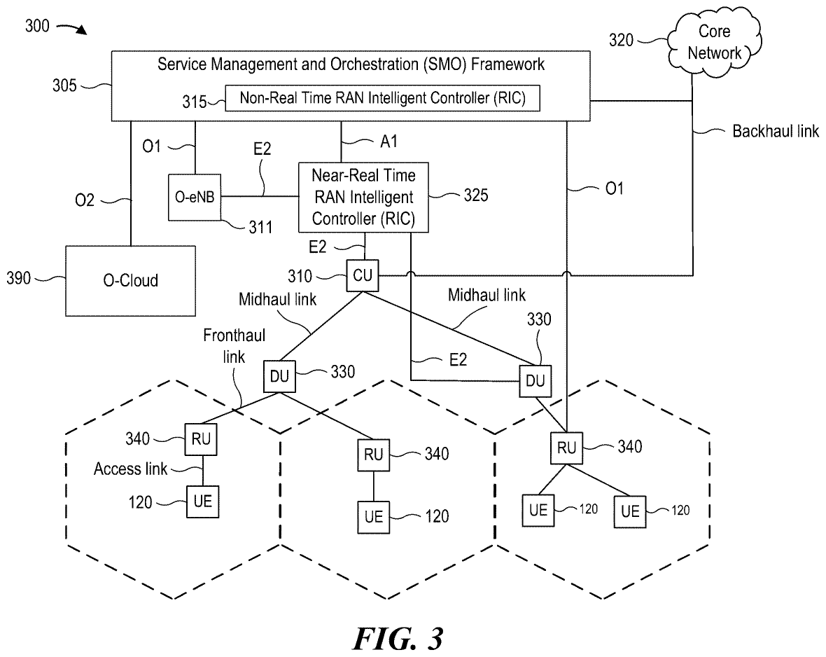

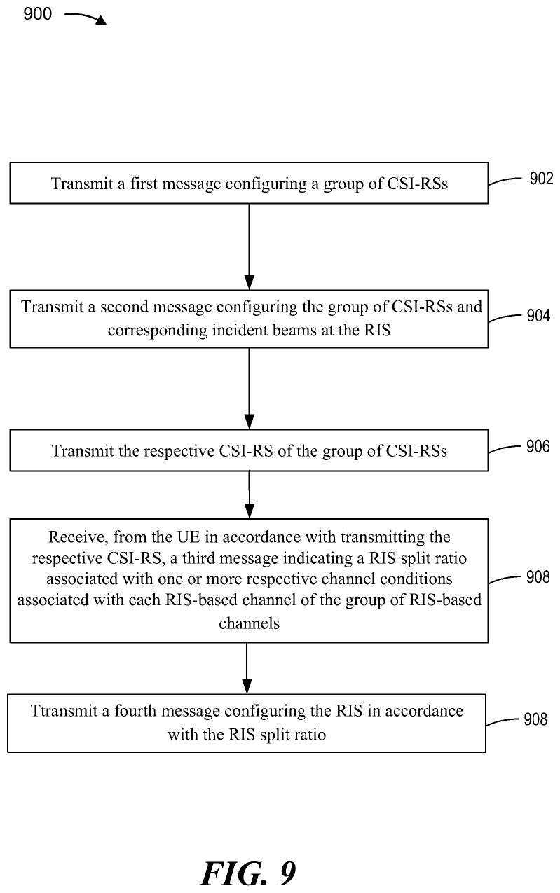

The core network 130 or the base stations 110 or any other network device (for example, as seen in FIG. 3) may include a RIS split module 138 that performs various operations, including operations of the process 900 described below with reference to FIG. 9.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (for example, remote device), or some other entity. A wireless node may provide, for example, connectivity for or to a network (for example, a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (for example, a system information block (SIB).

As indicated above, FIG. 1 is provided merely as an example. Other examples may differ from what is described with regard to FIG. 1.

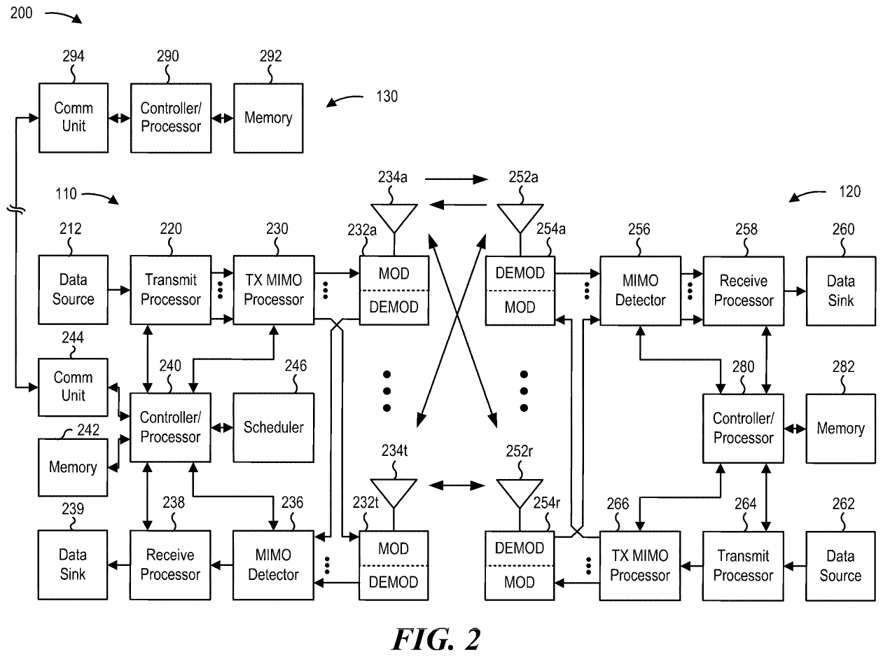

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (for example, encode and modulate) the data for each UE based at least in part on the MCS(s) selected for the UE, and provide data symbols for all UEs. Decreasing the MCS lowers throughput but increases reliability of the transmission. The transmit processor 220 may also process system information (for example, for semi-static resource partitioning information (SRPI) and/or the like) and control information (for example, CQI requests, grants, upper layer signaling, and/or the like) and provide overhead symbols and control symbols. The transmit processor 220 may also generate reference symbols for reference signals (for example, the cell-specific reference signal (CRS)) and synchronization signals (for example, the primary synchronization signal (PSS) and secondary synchronization signal (SSS)). A transmit (TX) multiple-input multiple-output (MIMO) processor 230 may perform spatial processing (for example, precoding) on the data symbols, the control symbols, the overhead symbols, and/or the reference symbols, if applicable, and may provide T output symbol streams to T modulators (MODs) 232a through 232t. Each modulator 232 may process a respective output symbol stream (for example, for orthogonal frequency division multiplexing (OFDM) and/or the like) to obtain an output sample stream. Each modulator 232 may further process (for example, convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (for example, filter, amplify, downconvert, and digitize) a received signal to obtain input samples. Each demodulator 254 may further process the input samples (for example, for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (for example, demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (for example, for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (for example, for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

The controller/processor 240 of the base station 110, the controller/processor 280 of the UE 120, and/or any other component(s) of FIG. 2 may perform one or more techniques associated with estimating a RIS allocation ratio as described in more detail elsewhere. For example, the controller/processor 240 of the base station 110, the controller/processor 280 of the UE 120, and/or any other component(s) of FIG. 2 may perform or direct operations of, for example, the processes of FIGS. 7 and 9 and/or other processes as described. Memories 242 and 282 may store data and program codes for the base station 110 and UE 120, respectively. A scheduler 246 may schedule UEs for data transmission on the downlink and/or uplink.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (for example, a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of Things (IoT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUS) 340 via respective fronthaul links. The RUs 340 may communicate with respective UEs 120 via one or more radio frequency (RF) access links. In some implementations, the UE 120 may be simultaneously served by multiple RUs 340.

Each of the units (for example, the CUS 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (for example, central unit-user plane (CU-UP)), control plane functionality (for example, central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via O1) or via creation of RAN management policies (such as A1 policies).

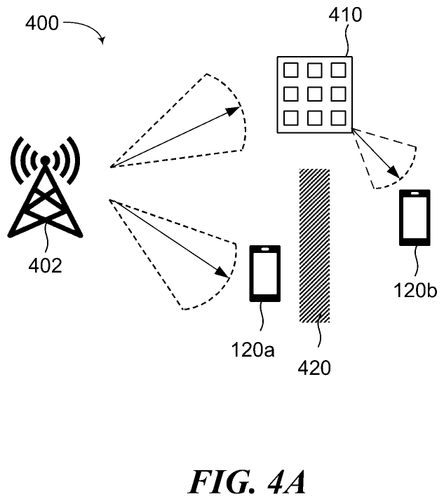

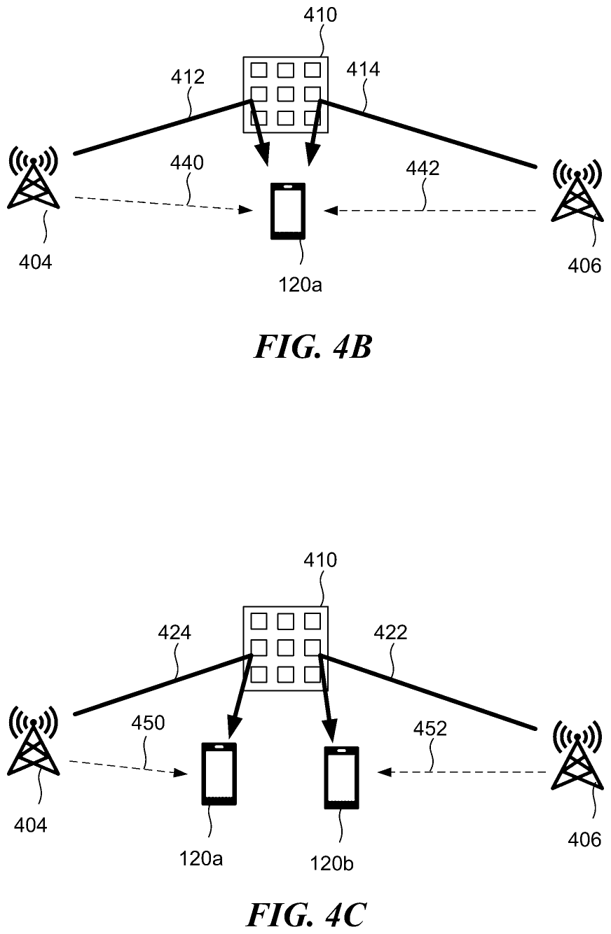

FIG. 4A is a block diagram illustrating a wireless communication network 400 employing a reconfigurable intelligent surface (RIS) 410 to extend network coverage. As shown in the example of FIG. 4A, the wireless communication network 400 also includes a network node 402 and two UEs 120a and 120b. The network node 402 may be an example of a base station 110 described with reference to FIGS. 1 and 2, or a CU 310, DU 330, or RU 340 described with reference to FIG. 3. In the example of FIG. 4A, an environmental feature 420, such as a building, a mountain, or another type of natural or manmade object, may block a signal from the network node 402 to the second UE 120b. In some examples, the second UE 120b may fail to receive the signal from the network node 402 due to the blockage. In contrast, the first UE 120a may directly receive a signal from the network node 402. In some other examples, a quality of the signal received at the second UE 120b from the network node 402 may be less than a signal quality threshold due to the blockage by the environmental feature 420. In contrast to conventional systems that deploy another assisting node to extend coverage to the second UE 120b, the example of FIG. 4A uses the RIS 410 to reflect the signal from the network node 402 around the environmental feature 420 (for example, around the blockage) to the second UE 120b. In such an example, the RIS 410 may extend network coverage of the wireless communication network 400 from the network node 402 to the second UE 120b.

In some examples, the RIS 410 may be controlled to reflect an impinging signal to a desired direction, such as toward the second UE 120b. In some such examples, the network node 402 may control the RIS 410. Additionally, or alternatively, the network node 402 may control the RIS 410 to adjust one or more characteristics of an impinging signal. These characteristics may include, for example, a phase, an amplitude, a frequency, or a polarization of a signal transmitted by the network node 402 or the UEs 120a and 120b. In some examples, one or more meta-elements of the RIS 410 may adjust the one or more characteristics of the impinging signal.

In some examples, a RIS may be in proximity to multiple network nodes (for example, TRPs). In some such examples, each network node may use the RIS for signal reflection. FIG. 4B is a block diagram illustrating an example of multiple network nodes 404 and 406 sharing a RIS 410 to reflect respective signals to a single UE 120a. Each network node 404 and 406 may be an example of a base station 110 described with reference to FIGS. 1 and 2, a CU 310, DU 330, or RU 340 described with reference to FIG. 3, or a network node 402 described with reference to FIG. 4A. In the example of FIG. 4B, each network node 404 and 406 establishes a respective RIS-based channel 412 and 414 with the UE 120a. The RIS-based channels 412 and 414 may also be referred to as RIS-based channels. Each RIS-based channel 412 and 414 is an example of a communication link between the UE 120a and a respective network node 404 and 406 that is established via the RIS 410. In the example of FIG. 4B, the RIS 410 is an example of a shared RIS. In contrast to a non-shared RIS, where only one reflection is possible, the shared RIS may enable two or more simultaneous reflections, thereby, improving a combined channel gain associated with the network nodes 404 and 406. The improved channel gain may increase throughput for the UE 120a. In some examples, the RIS 410 may simultaneously reflect signals associated with the RIS-based channels 412 and 414. In some examples, in addition to communicating with the UE 120a via a respective communication link on each RIS-based channel 412 and 414, each network node 404 and 406 may communicate with the UE 120a via a respective communication link on each direct channel 440 and 442. In other examples, each network node 404 and 406 may be limited to communicating with the UE 120a via the respective RIS-based channels 412 and 414.

In other examples, each network node may use a RIS for signal reflection to a UE of a group of UEs. FIG. 4C is a block diagram illustrating an example of multiple network nodes 404 and 406 sharing a RIS 410 to reflect respective signals to a group of UE 120a, 120b. In the example of FIG. 4C, each network node 404 and 406 establishes a respective RIS-based channel 424 and 422 with a respective UE 120a, 120b. Each RIS-based channel 424 and 422 is an example of a communication link between each UE 120a and 120b and a respective network node 404 and 406 that is established via the RIS 410. In the example of FIG. 4C, the RIS 410 may be at a border of two cells, each cell associated with a respective network node 404 and 406. In some examples, in addition to communicating with each UE 120a and 120b via a respective communication link on each RIS-based channel 424 and 422, each network node 404 and 406 may communicate with each UE 120a and 120b via a respective communication link on each direct channel 450 and 452. In other examples, each network node 404 and 406 may be limited to communicating with each UE 120a and 120b via the respective RIS-based channels 424 and 422.

As discussed, in some examples, a RIS may reflect signals from a group of network nodes, such as two or more network nodes, to a single UE. In some such examples, the RIS may be divided between the two or more network nodes. Each part may be designated for reflection from one network node to the UE. The division of the RIS may be based on a RIS allocation ratio. Specifically, the RIS allocation ratio indicates a number of meta-elements allocated to each network node of the group of network nodes. Different RIS allocation ratios may lead to varying channel capacities. A beamforming gain associated with the RIS reflection may be related to the number of meta-elements allocated to a network node. An allocation of more meta-elements to a given network node, in comparison to an allocation of meta-elements to other network nodes, enhances the beamforming gain and subsequently the link quality of the given network node, while reducing the beamforming gain and link quality of the other network nodes. A total channel capacity may be a sum of the capacities of the links from each network node of the group of network nodes. Therefore, the total channel capacity may be increased or maximized by selecting an appropriate RIS allocation ratio.

In a frequency division duplexing (FDD) system, in comparison to a network node, the UE may have more precise channel information as a result of channel measurements associated with one or more CSI-RSs. The network node is an example of a TRP. In some examples, the UE may determine the RIS allocation ratio based on measurements of the respective RIS-based channels. In some examples, the UE determines and reports the optimal RIS allocation ratio for a shared-RIS-based. The optimal RIS allocation ratio may be a ratio that increases or maximizes the total channel capacity. In some examples, a network node may configure a new CSI metric, such as a RIS allocation ratio metric, at the UE. This CSI metric may be associated with two or more RIS-based CSI-RS resources. Each RIS-based CSI-RS resource corresponds to a different network node and the same RIS. The two RIS-based CSI-RS resources may be associated with different time occasions. At each time occasion, the RIS may reflect one or more CSI-RSs from one network to a certain direction via one or more meta-elements.

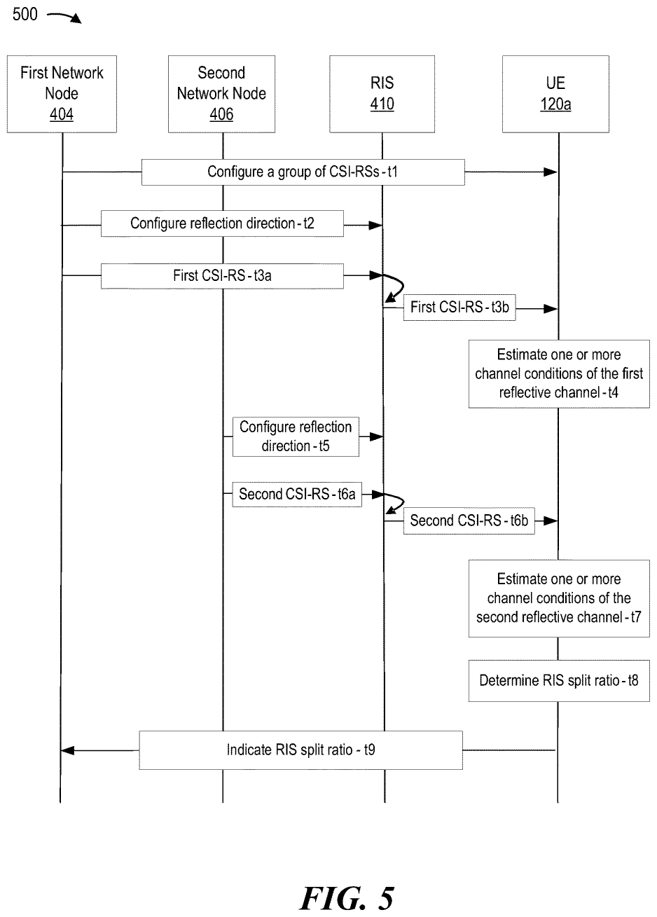

FIG. 5 is a timing diagram illustrating an example 500 of a UE 120a determining a RIS allocation ratio, in accordance with various aspects of the present disclosure. In the example of FIG. 5, multiple network nodes 404 and 406 share a RIS 410 to reflect respective signals to the UE 120a. Aspects of the present disclosure are not limited to two network nodes 404 and 406 sharing the RIS 410. The RIS 410 may be shared between any number of network nodes. For ease of explanation, FIG. 5 is limited to two network nodes 404 and 406.

As shown in the example 500 of FIG. 5, at time t1, a first network node 404 transmits a first message, to the UE 120a, configuring a group of CSI-RSs (for example, RIS-based CSI-RSs). Each CSI-RS of the group of CSI-RSs may be associated with a RIS-based channel of a group of RIS-based channels. Each RIS-based channel, of the group of RIS-based channels, may be associated with a respective communication link between a respective network node, of the group of network nodes 404 and 406, and the UE 120a via the RIS 410.

At time t2, the first network node 404 may transmit a message, to the RIS 410, configuring a reflection direction for signals transmitted from the first network node 404 to the UE 120a via the RIS 410. The RIS 410 may configure one or more meta-elements to reflect a signal to the UE 120a in accordance with the configuration received at time t2. The message transmitted by the first network node 404, at time t2, may configure one or more first CSI-RS resources and a corresponding incident beam index. The incident beam index may be explicitly indicated in terms of direction angles or implicitly associated with a previous beam or CSI-RS resource transmitted by the first network node 404. Additionally, for each CSI-RS resource, the first network node 404 may configure a set of reflective beams for multiple ports at the RIS 410. In some examples, the RIS 410 is expected to reflect one or more first CSI-RSs with the entire surface without any splitting. Once the RIS reflects the one or more first CSI-RSs based on the configured incident and reflective beams, the UE 120a may estimate a channel matrix of the first RIS-based channel (for example, RIS-based channel) from the first network node 404 to the UE 120a.

At time t3a, the first network node 404 may transmit one or more first CSI-RSs to the RIS 410, and, at time t3b, the RIS 410 may reflect the one or more first CSI-RSs to the UE 120a, in accordance with the configuration received at time t2. As discussed, the RIS 410 may reflect the one or more first CSI-RSs using the entire surface of the RIS 410. The one or more first CSI-RSs may be transmitted on a first RIS-based channel, such as the first RIS-based channel 412 described with reference to FIG. 4B. The first RIS-based channel may be associated with a first communication link between the first network node 404 and the UE 120a via the RIS 410. At time t4, the UE 120a may estimate one or more channel conditions of the first RIS-based channel based on measuring the one or more first CSI-RSs received at time t3b.

At time t5, the second network node 406 may transmit a message, to the RIS 410, configuring a reflection direction for signals transmitted from the second network node 406 to the UE 120a via the RIS 410. The RIS 410 may configure one or more meta-elements to reflect a signal to the UE 120a in accordance with the configuration received at time t5. The message transmitted by the second network node 406, at time t5, may configure one or more first CSI-RS resources and a corresponding incident beam index. The incident beam index may be explicitly indicated in terms of direction angles or implicitly associated with a previous beam or CSI-RS resource transmitted by the second network node 406. Additionally, for each CSI-RS resource, the second network node 406 may configure a set of reflective beams for multiple ports at the RIS 410. In some examples, the RIS 410 is expected to reflect one or more first CSI-RSs with the entire surface without any splitting. Once the RIS 410 reflects the one or more first CSI-RSs based on the configured incident and reflective beams, the UE 120a may estimate a channel matrix of the second RIS-based channel (for example, RIS-based channel) from second network node 406 to the UE 120a.

At time t6a, second network node 406 may transmit one or more second CSI-RSs to the RIS 410, and, at time t6b, the RIS 410 may reflect the one or more second CSI-RSs to the UE 120a, in accordance with the configuration received at time t5. The one or more second CSI-RSs may be transmitted on a second RIS-based channel, such as the second RIS-based channel 414 described with reference to FIG. 4B. The second RIS-based channel may be associated with a second communication link between the second network node 406 and the UE 120a via the RIS 410. At time t7, the UE 120a may estimate one or more channel conditions of the second RIS-based channel based on measuring the one or more second CSI-RSs received at time t6b.

At time t8, the UE 120a may determine a RIS allocation ratio associated with the estimated one or more respective channel conditions (times t4 and t7) for each RIS-based channel of the group of RIS-based channels. The RIS allocation ratio may be represented as a set of fractions, in which each fraction, of the set of fractions, corresponds to a respective node. For example, the RIS allocation ratio may be [1/3, 2/3] for a set of network nodes. In this example, a first network node, of the set of network nodes, may be allocated one-third of the total number of the meta-elements of the RIS and a second network node, of the set of network nodes, may be allocated two-thirds of the total number of the meta-elements of the RIS. As another example, the RIS allocation may be [1, 0] for the set of nodes. In this example, the first network node may be allocated all of the meta-elements of the RIS and the second network node none of the meta-elements are allocated to the second network node. Aspects of the present disclosure are not limited to allocating meta-elements to two network nodes. The meta-elements may be allocated to two or more network nodes. The RIS allocation ratio may be associated with a maximum total channel capacity that is a collective sum of respective channel capacities of the group of RIS-based channels. Additionally, or alternatively, at time t8, the UE 120a may determine reflection coefficients w̅_{r,1} and w̅_{r,2} for the split meta-elements of the RIS 410 associated with the RIS allocation ratio. At time t9, the UE 120a transmits a message indicating the RIS allocation ratio to the first network node 404. The message transmitted at time t9 may also include the reflection coefficients w̅_{r,1} and w̅_{r,2}. The message may be transmitted via L1 signaling, such as via a CSI report, a MAC-CE, or RRC signaling. Additionally, or alternatively, the UE 120a may determine other CSI metrics, such as a rank indicator (RI), a precoding matrix indicator (PMI), or a channel quality index (CQI). The other CSI metrics may also be indicated in the same message that indicates the RIS allocation ratio.

After receiving the message at time t9, the first network node 404 may then configure the RIS 410 based on the RIS allocation ratio, such that the RIS 410 allocates meta-elements to the network nodes 404 and 406 in accordance with the RIS allocation ratio. In some examples, the RIS allocation ratio indicates a respective amount of meta-elements, of a group of meta-elements associated with the RIS 410, allocated to each network node 404 and 406. Each meta-element of the group of meta-elements may be associated with an adjustment to one or both of a phase or amplitude of a signal.

As discussed, a UE may estimate a channel matrix for each RIS-based channel based on one or more respective channel conditions associated with measuring the one or more CSI-RSs corresponding to the RIS-based channel. In the end, the UE may estimate a cascading channel matrix A_{m,i} for an m-th antenna at a network node i. Specifically, the cascading channel matrix A_{m,i} may be determined as follows:

$${A}_{m , i} {=}^{△} {H}_{ru} \cdot Diag ( {H}_{gr , i} ( : , m ) ) ∈ {ℂ}^{{N}_{u} \times {N}_{r}} , i = 1 or 2 , m = 1 ∼ {N}_{g , i} . \qquad ( 1 )$$

In Equation 1, Hᵣᵤ represents a channel matrix from a RIS to the UE, and H_{gr,i} represents a channel matrix from the network node i to the RIS. Additionally, H_{gr,i}(:,m) represents a channel vector from the m-th antenna at network node i to the RIS. Furthermore, N_{g,i} represents a number of antennas at node i. A_{m,i} represents the cascading channel matrix for the m-th antenna in the network node i. The cascading channel matrix A_{m,i} represents the overall channel response from the m-th antenna in node i to the UE, taking into account the reflections from the RIS. As shown in Equation 1, the cascading channel matrix A_{m,i} is a product of the channel matrix from a RIS to the UE Hᵣᵤ and the diagonal matrix that includes the diagonal elements of the channel matrix H_{gr,i}(:,m) from the network node i to the RIS. The result is a complex matrix of size Nᵤ×Nᵣ, where Nᵤ represents a number of antennas at the UE and Nᵣ represents a number of meta-elements at the RIS.

In some examples, when node i transmits a precoded signal from all transmission (Tx) antennas, the UE receives a signal yᵢ, which may be represented as:

$${y}_{i} = {H}_{ru} \cdot Diag ( {w}_{r} ) \cdot {H}_{gr , i} \cdot {W}_{g , i} x + noise = [ {A}_{i , 1} , {A}_{i , 2} , … , {A}_{i , {N}_{g}} ] \cdot ( {I}_{{N}_{g , i}} ⊗ {w}_{r} ) \cdot {W}_{g , i} x + noise . \qquad ( 2 )$$

In Equation 2, wᵣ represents a reflection coefficient at the RIS, and W_{g,i} represents a precoding weight at the network node i. The reflection coefficients wᵣ represent an amount of energy reflected by meta-elements of the RIS. By adjusting the reflection coefficients of each meta-element, the RIS can steer the reflected waves in specific directions and enhance the signal strength at the receiver. The received signal is a result of the transmission of precoded signal x from the network node i, which is transmitted through a cascading channel matrix represented by |A_{i,1}, A_{i,2}, . . . , A_{i,N}_{_{g}}, where N_{g} represents the number of antennas at the network node i. The precoded signal may be transmitted using a precoding weight W_{g,i}. Before reaching the UE, the signal reflects off the RIS. The reflection at the RIS is controlled by the reflection coefficient vector wᵣ. The signal received at the UE may be distorted by noise. In Equation 2, I_{N}_{_{g,i}} represents an identity matrix having size N_{g,i}.

As discussed, the RIS allocation ratio indicates a respective amount of meta-elements, of a group of meta-elements associated with the RIS, allocated to each network node. For ease of explanation, the following examples will be directed to splitting the meta-elements into two parts, where a first set of meta-elements [symbol] may be assigned to a first network node and a second set of meta-elements [symbol] may be assigned to a second network node. In such examples, only a subset of columns in the cascading matrix A_{m,i} may be retained for each node. In some examples, a size of the first set of meta-elements [symbol] is | [symbol] |=s₁, the size of the second set of meta-elements [symbol] is | [symbol] |=s₂, and the RIS allocation ratio

$$γ = \frac{{s}_{1}}{{s}_{2}} .$$

Each cascading matrix A_{m,i} may correspond to one meta-element in the RIS. For the first network node, the cascading matrix is divided into two sets of columns, A_{m,1}=[Ā_{m,1}, A̅_{m,1}], and for the second network node, the cascading matrix is divided into two sets of columns A_{m,2}=[Ā_{m,2}, A̅_{m,2}]. The column separation between Ā_{m,i} and A̅_{m,i} may be based on the meta-elements dividing the sets of meta-elements [symbol] and [symbol] . Assuming the sets of meta-elements [symbol] and [symbol] are allocated to the first network node and the second network node, respectively, then the retained matrix is Ā_{m,1} for the first network node and A̅_{m,2} for the second network node. Thus, the received signal from the first node may be represented as y₁=[Ā_{1,1}, Ā_{1,2}, . . . , Ā_{1,N}_{_{g,1}}]·(I_{N}_{_{g}}_{,1}⊗w̅_{r,1})·W_{g,1}x+noise, where w̅_{r,1} represents a reflection coefficient of the first set of meta-elements [symbol] 1, and [Ā_{1,1}, Ā_{1,2}, . . . , Ā_{1,N}_{_{g,1}}] represents a group of cascading channel matrices, which may be a concatenation of column vectors. Each column vector, such as Ā_{1,1}, corresponds to the cascading channel matrix for one meta-element in the first set of meta-elements [symbol] ₁ from a particular antenna in the first network node. Additionally, the received signal from the second network node may be represented as y₂=[A̅_{2,1}, A̅_{2,2}, . . . , A̅_{2,N}_{_{g,2}}]. (I_{N}_{_{g}}_{,2}⊗w̅_{r,2})·W_{g,2}x+noise, where ŵ_{r,2} represents the reflection coefficient of the second set of meta-elements [symbol] ₂, and [A̅_{2,1}, A̅_{2,2}, . . . , A̅_{2,N}_{_{g,2}}] represents a group of cascading channel matrices, which may be a concatenation of column vectors. Each column vector, such as A̅_{2,1}, corresponds to the cascading channel matrix for one meta-element in the second set of meta-elements [symbol] ₂ from a particular antenna in the second network node.

In some examples, the UE may determine an optimal RIS allocation ratio γ and reflection coefficients w̅_{r,1} and w̅_{r,2} to increase or maximize a total channel capacity of the RIS-based channels, where H₁ represents a channel matrix associated with the first RIS-based channel and H₂ represents a channel matrix associated with the second RIS-based channel. Specifically, H₁ ≙[Ā_{1,1}, Ā_{1,2}, . . . , Ā_{1,N}_{_{g,1}}]·(I_{N}_{_{g}}_{,1}⊗w̅_{r,1}) and H₂ ≙[A̅_{2,1}, A̅_{2,2}, . . . , A̅_{2,N}_{_{g,2}}]·(I_{N}_{_{g}}_{,2}⊗w̅_{r,2}). w̅_{r,1} represent a major singular vector of cascading channel matrices [Ã_{1,1}; Ã_{1,2}; . . . ; Ā_{1,N}_{_{g,1}}]. The singular values are a set of non-negative numbers that can be computed from a matrix. Therefore, the singular values of the first RIS-based channel H₁ may be calculated as α_{1,1}, . . . , α_{1,N}_{ᵤ}. Additionally, w̅_{r,2} represents a major singular vector of cascading channel matrices [A̅_{2,1}; A̅_{2,2}; . . . , A̅_{2,N}_{_{g,2}}]. Thus, the singular values of the second RIS-based channel H₂ may be calculated as α_{2,1}, . . . , α_{2,N}_{ᵤ}. Therefore, a total channel capacity C of the two RIS-based channels may be expressed as

$$C = {\sum }_{i = 1}^{2} {\sum }_{n = 1}^{{N}_{u}} {log}_{2} ( 1 + SNR \cdot {α}_{i , n} ) .$$

Thus in some examples, the UE determines the RIS allocation ratio γ to increase or maximize the total channel capacity. The total channel capacity C may be a sum of the capacity of the two RIS-based channels, where i represents an index of the network node, and n represents an index of the antenna at UE. The capacity of each link is given by log₂(1+SNR·α_{i,n}), where α_{i,n} represents a singular value of the cascading channel matrix for the n-th antenna at node i, and SNR represents the signal-to-noise ratio at the UE. The capacity of a communication channel is a measure of the maximum rate at which information can be transmitted over the channel

In some examples, the RIS may only support a set of RIS allocation ratios γ. In such examples, the RIS may report the set of supported RIS allocation ratios [symbol] (for example, supported candidate split ratio) to the network node, where, for example

$${𝕊}_{γ} = \{ \frac{1}{1} , \frac{1}{2} , \frac{2}{1} , … \} .$$

The network node may then indicate the supported RIS allocation ratios [symbol] to the UE. In such examples, the UE may determine an optimal RIS allocation ratio γ (for example, γₒₚₜ) based on supported RIS allocation ratios [symbol] , such that γₒₚₜ∈ [symbol] .

As discussed, in some examples, each network node may communicate with a UE via a link on a direct channel, such as the direct channels 440 and 442 described with reference to FIG. 4B. In such examples, a total channel capacity associated with each network node may consider the respective RIS-based channel and the respective direct link. For example, for a first network node, the total channel capacity may be based on an updated channel matrix Ã₁, where

$${\tilde{H}}_{1} = [ {\tilde{A}}_{1 , 1} , {\tilde{A}}_{1 , 2} , … , {\tilde{A}}_{1 , {N}_{g , 1}} ] \cdot ( {I}_{{N}_{g , 1}} ⊗ [ \begin{matrix}1 \\ {\overline{w}}_{r , 1}\end{matrix} ] ) , where {\tilde{A}}_{1 , m} {=}^{△} [ {H}_{gu , 1} ( : , m ) , {\tilde{A}}_{1 , m} ] . {H}_{gu , 1}$$

represents a channel matrix associated with a direct channel, such as the direct channel 440 described with reference to FIG. 4B, between a first node and the UE. H_{gu,1}(:,m) represents a channel vector from the m-th antenna of the first network node to the UE. Ā_{1,m} may be derived, by concatenation, the channel vector H_{gu,1}(:,m) and a corresponding cascading channel matrix Ā_{1,m} associated with the m-th antenna. Specifically, a first group of cascading channel matrices [Ã_{1,1}, Ã_{1,2}, . . . , Ã_{1,N}_{_{g,1}}] may be generated by concatenating a channel matrix H_{gu,1}, associated with a respective direct link between the first network node and the UE, and a respective second group of cascading channel matrices [Ā_{1,1}; Ā_{1,2}; . . . ; Ā_{1,m}] associated with the one or more respective channel conditions of the RIS-based channel. An updated channel matrix \tilde{H}₂ associated with the second network node may be derived similar to the updated channel matrix \tilde{H}₁ associated with the first network node. For example,

$${\tilde{H}}_{2} = [ {Ã}_{2 , 1} , {Ã}_{2 , 2 ,} {Ã}_{2 , {N}_{g , 2}} ] \cdot ( {I}_{{N}_{g , 2}} ⊗ [ \begin{matrix}1 \\ {\overline{w}}_{r , 2}\end{matrix} ] ) ,$$

where Ā_{2,m}≙[H_{gu,2}(:,m), A̅_{2,m}]. In such examples, the UE may determine the optimal RIS split y and corresponding reflection coefficients w̅_{r,1} and w̅_{r,2}, so that the total channel capacity associated with the updated channel matrices \tilde{H}₁ and \tilde{H}₂ may be increased or maximized.

As discussed, the UE may estimate a RIS-based channel by measuring one or more CSI-RSs. In some examples, the RIS-based channel may be estimated via a per-element on-off technique, a least squares (LS) technique, a compressing sensing (CS) technique, or another technique. Per-element on-off refers to an ability of the RIS to activate or deactivate individual elements, such that, each meta-element of the RIS can be turned on or off independently. When the RIS is configured to switch on each element, the corresponding reflection coefficient vector w_{r,t} is set to a vector of zeros [0, . . . 0,1,0, . . . , 0]^{T} with a single value of one at the position of the element being activated. Accordingly, a corresponding column of the cascading channel matrix Aₘ may be derived to optimize the reflected signal.

In other examples, the LS technique may be used to estimate the cascading channel matrix Aₘ. In such examples, the cascading channel matrix Aₘ may be calculated by multiplying a conjugate transpose of a known matrix B and the inverse of the product of B and its conjugate transpose ((BB^{H})⁻¹. Specifically, Âₘ=YₘB^{H}(BB^{H})⁻¹. In some examples, a rank of the matrix B should be equal to the number of rows or columns of B, whichever is smaller. This condition implies that the number of transmit antennas T should be greater than or equal to the number of reflecting elements (T≥Nᵣ). The LS technique is particularly suitable for scenarios where the number of reflecting elements is small, as it can provide a reliable estimate of the channel matrix with relatively low complexity. However, in cases where the number of reflecting elements is large, the LS technique may not be practical due to the computational complexity of inverting large matrices. In such scenarios, other techniques such as CS may be more appropriate.

CS is a signal processing technique that allows for the efficient acquisition and reconstruction of signals that are sparse or compressible. CS is based on the idea that signals that are sparse in one domain, such as the frequency domain, can be represented using a small number of measurements in a different domain, such as the time domain. In some cases, if the number of variables is large, the complexity of CS becomes high. CS may be suitable for use cases with a small number of variables, such as when the RIS incident direction is already known through pre-measurement. In this case, the channel matrix is represented as a linear combination of the sparse paths with corresponding gains and steering vectors.

As discussed, in some examples, such as the example described with reference to FIG. 4C, two or more network nodes may share a RIS to communicate with respective UEs. In such examples, the RIS may be divided between the two or more network nodes because incident directions of the respective signals from each network node may be different. The RIS allocation ratio affects the channel capacities of the system, as allocating more meta-elements to one network node enhances the beamforming gain and quality of a link associated with the network node, while reducing the beamforming gain and quality of the link of another network node.

In such examples, an optimal RIS allocation ratio may be determined to increase or maximize a total channel capacity. In some such examples, a network node may determine the split ratio and multi-user (MU) MIMO (MU-MIMO) schedule based on CSI reports from multiple UEs. Because each UE cannot know the channel situation of the other UE, each UE may be requested to report CSI values for multiple partial-RIS hypotheses to provide sufficient scheduling flexibility. The network node may then determine the RIS allocation ratio that leads to the maximum sum-capacity of the paired UEs.

In some examples, each network node may transmit a message, to the RIS, configuring a reflection direction for signals transmitted from the respective network node. The RIS may configure one or more meta-elements to reflect a signal to each UE in accordance with the configuration received from the respective network node. Specifically, each message, from a respective network node of a group of network nodes, may configure one or more CSI-RS resources and a corresponding incident beam index. The incident beam index may be explicitly indicated in terms of direction angles or implicitly associated with a previous beam or CSI-RS resource transmitted by the respective network node. Additionally, for each CSI-RS resource, the network node may configure a set of reflective beams for multiple ports at the RIS. In some examples, prior to determining the RIS allocation ratio, the RIS is expected to reflect one or more CSI-RSs with the entire surface without any splitting.

Additionally, in some examples, each network node may transmit, to a respective UE of a group of UE, a CSI report configuration message. The CSI report configuration message may be associated with a different RIS-based CSI-RS resource and indicates a set of partial-RIS hypotheses {γ₁, γ₂, . . . , γ_{K}} (for example, {1, ½, ⅓, ⅔, ¼, ¾, . . . }). In such examples, the RIS reports a set of supported candidate split ratio values to each network node, and the network node configures a set of partial-RIS hypotheses to the respective UE based on this set of supported candidate split ratio values. One partial-RIS hypothesis is a ratio value 0<γₖ≤1, such that a certain portion (percentage) of RIS may be used by the respective UE.

After transmitting the CSI report configuration message, each network node may transmit one or more CSI-RSs to an associated UE via a RIS-based channel of the network node. As discussed, the one or more CSI-RSs transmitted from the network node may be reflected from the RIS to the associated UE. Each UE may estimate a channel matrix of a corresponding RIS-based channel based on one or more channel conditions estimated by measuring the one or more CSI-RSs. As an example, a first network node may transmit one or more first CSI-RSs to a first UE via a first RIS-based channel and a second network node may transmit one or more second CSI-RSs to a second UE via a second RIS-based channel. Both the first and second RIS-based channels may be reflected from the same RIS.

Each UE i may estimate a cascading channel matrix A_{m,i} based on the one or more channel conditions, where A_{m,i}≙H_{ru,i}. Diag(H_{gr,i}(:,m))∈ [symbol] , m=1~N_{g,i}, i=1 or 2. H_{ru,i} represents a channel matrix from the RIS to the UE i, H_{gr,i} represents a channel matrix from a network node i to the RIS. H_{gr,i}(:,m) represents a channel vector from the m-th antenna in the network node i to the RIS. N_{u,i} represents a number of antennas at UE i, Nᵣ represents a number of meta-elements at the RIS, N_{g,i} represents a number of antennas at node i. A_{m,i} represents a cascading channel matrix for the m-th antenna in the network node i. When the network node i transmits a precoded signal from all the Tx antennas, the received signal at UE yᵢ may be represented as: yᵢ=H_{ru,i}·Diag(wᵣ)·H_{gr,i}·W_{g,i}x+noise=[A_{i,1}, A_{i,2}, . . . , A_{i,N}_{_{g}}]·(I_{N}_{_{g,i}}⊗wᵣ)·W_{g,i}x+noise, where wᵣ represents the reflection coefficient at the RIS, and W_{g,i} represents a precoding weight at the network node i.

As discussed, a network node i may indicate, to a UE i, a set of partial-RIS hypotheses {γ₁, γ₂, . . . , γ_{K}}. In some examples, for each configured partial-RIS hypothesis γₖ, the UE i determines a CSI value, such as an RI, PMI, and/or CQI. In such examples, Nᵣ represents a total number of meta-elements at a RIS. Thus, for a partial-RIS hypothesis γₖ, a number of the used meta-elements at the RIS may be represented as N_{r,k}≙└Nᵣγₖ┘. For the UE i, each column of the cascading matrix A_{m,i} corresponds to one meta-element at the RIS. For one partial-RIS hypothesis γₖ, the cascading matrix A_{m,i} only retains its N_{r,k} columns. In some examples, for simplicity but without loss of generality, the cascading matrix A_{m,i} may only retain its first N_{r,k} columns, denoted as Ā_{m,i,k}=A_{m,i}(:,1:N_{r,k}). Therefore, the received signal yᵢ from the network node i to the UE i may be represented as

$${y}_{i} = [ {\overline{A}}_{1 , i , k} , {\overline{A}}_{2 , i , k} , … , {\overline{A}}_{{N}_{g , i} , i , k} ] \cdot ( {I}_{{N}_{g} , i} ⊗ {\overline{w}}_{r , k} ) \cdot {W}_{g , i} x + noise ,$$

where w̅_{r,k} represents the reflection coefficients of the partial-RIS hypothesis γₖ. To calculate the CSI value, the reflection coefficients w̅_{r,k} may be set with a major singular vector of

$$[ {\overline{A}}_{1 , i , k} ; {\overline{A}}_{2 , i , k} ; … ; {\overline{A}}_{{N}_{g , i} , i , k} ] ,$$

then the RI, the PMI, and the CQI may be calculated based on the equivalent channel matrix

$${H}_{i , k} {=}^{△} [ {\overline{A}}_{1 , i , k} , {\overline{A}}_{2 , i , k} , … , {\overline{A}}_{{N}_{g , i} , i , k} ] \cdot ( {I}_{{N}_{g , i}} ⊗ {\overline{w}}_{r , k} ) .$$

In some examples, a direct link may be established via a direct channel, such as the direct channels 450 and 452 described with reference to FIG. 4C. In such examples, if the direct link between the network node i and the UE i exists, then the channel matrix H_{i,k} may be updated as

$${\tilde{H}}_{i , k} = [ {\tilde{A}}_{1 , i , k} , {\tilde{A}}_{2 , i , k} , … , {\tilde{A}}_{{N}_{g , i} , i , k} ] \cdot ( {I}_{{N}_{g , i}} ⊗ [ \begin{matrix}1 \\ {\overline{w}}_{r , k}\end{matrix} ] ) ,$$

where a cascading matrix Ā_{m,i,k}≙[H_{gu,i}(:,m),Ā_{m,i,k}]. Additionally, the UE i may determine the reflection coefficients w̅_{r,k} and corresponding CSI for each partial-RIS hypothesis γₖ.

After the UE i determines CSI values for multiple partial-RIS hypotheses, the UE i can report them to the network node i. This report may be transmitted via L1 signaling (for example, via a CSI report), a MAC-CE, or RRC signaling. In some examples, the UE i reports multiple CSI values. Each CSI value may include an RI, PMI, and/or CQI associated with a certain partial-RIS hypothesis γₖ, following the order of the configured partial-RIS hypotheses set {γ₁, γ₂, . . . , γ_{K}}. In other examples, the UE i may collectively report multiple CSI values. In such examples, the UE i reports one absolute value of the CQI for a first partial-RIS hypothesis γ₁ and K−1 relative values of a CQI for other partial-RIS hypotheses {γ₂, . . . , γ_{K}} based on the first partial-RIS hypothesis γ₁. In other examples, the UE i selects a subset K′ of partial-RIS hypothesis, where K′<K, based on a CQI value, such as each partial-RIS hypothesis having a CQI value that is greater than a threshold. The UE i may report a respective index of each of partial-RIS hypothesis γₖ in the subset K′ of partial-RIS hypotheses and their corresponding CSI values.

Upon receiving a respective CSI report, from a UE, for each partial-RIS hypothesis γₖ of a set of partial-RIS hypotheses {γ₁, γ₂, . . . , γ_{K}}, or the subset K′ of partial-RIS hypothesis, each network node may determine an optimal UE pairing and corresponding RIS allocation ratio. In some examples, one network node from a group of network nodes may receive the respective CSI reports from each UE of a group of UEs. In such examples, the network node may generate a list of candidate inter-UE CSI pairs based on the associated partial-RIS hypotheses. For example, if a first CSI value from a first UE is associated with a first partial-RIS hypothesis γₖ, and a second CSI value from a second UE is associated with a second first partial-RIS hypothesis γ_{k′}, and γₖ+γ_{k′}≤1, then these two UEs and their corresponding CSI values may be paired. Additionally, a total sum capacity of these two CSI values may be recorded as a candidate. The network node may then select an optimal inter-UE CSI pair from the candidate list that has the largest total sum capacity. Based on the determined optimal inter-UE CSI pair, the network node may configure the RIS allocation ratio and the transmission format, such as a modulation and coding scheme (MCS) and a number of layers, for each UE, based on the RIS allocation ratio.

Various aspects of the present disclosure may increase overall throughput of a RIS-split-based MU-MIMO, thereby improving system efficiency. As discussed, in some examples, each network node configures a RIS to reflect CSI-RSs from the respective network node to an associated UE. In such examples, the RIS may use an entire RIS surface to reflect the CSI-RSs. In other examples, a single network node of a group of network nodes may configure the RIS to reflect the CSI-RS to different UEs of a group of UEs, where each UE is served by a different network node. In some examples, each UE may be configured to generate a CSI report based on measuring one or more CSI-RSs reflected from the RIS on a RIS-based channel. Additionally, each UE may receive a set of partial-RIS hypotheses supported by the RIS. Furthermore, each UE may report respective CSI values for each partial-RIS hypothesis of the set of partial-RIS hypotheses.

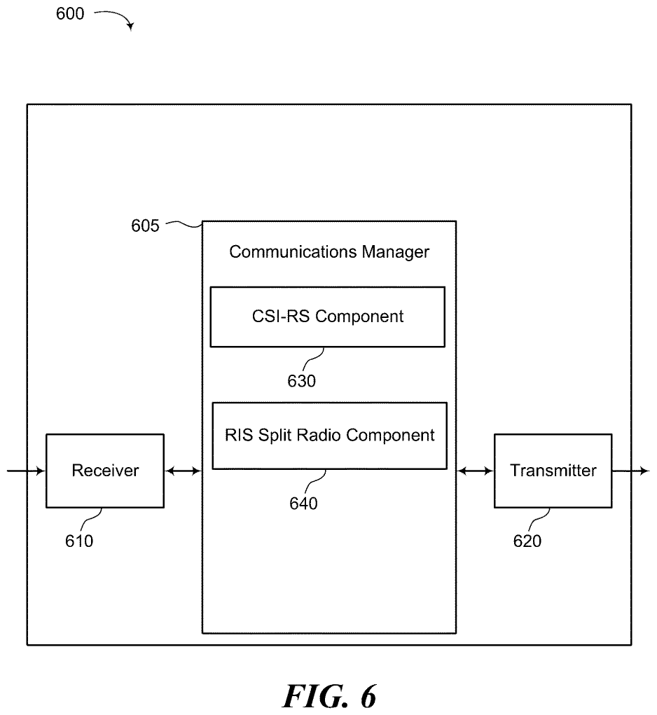

FIG. 6 is a block diagram illustrating an example wireless communication device 600 that supports estimating a RIS allocation ratio, in accordance with some aspects of the present disclosure. The device 600 may be an example of aspects of a UE 120 described with reference to FIGS. 1, 2, 3, 4A, 4B, 4C, and 5. The wireless communication device 600 may include a receiver 610, a communications manager 605, a transmitter 620, a CSI-RS component 630, and a RIS allocation ratio component 640 which may be in communication with one another (for example, via one or more buses). In some examples, the wireless communication device 600 is configured to perform operations, including operations of the process 700 described below with reference to FIG. 7.

In some examples, the wireless communication device 600 can include a chip, chipset, package, or device that includes at least one processor and at least one modem (for example, a 5G modem or other cellular modem). In some examples, the communications manager 605, or its sub-components, may be separate and distinct components. In some examples, at least some components of the communications manager 605 are implemented at least in part as software stored in a memory. For example, portions of one or more of the components of the communications manager 605 can be implemented as non-transitory code executable by the processor to perform the functions or operations of the respective component.

The receiver 610 may receive one or more of reference signals (for example, periodically configured channel state information reference signals (CSI-RSs), aperiodically configured CSI-RSs, or multi-beam-specific reference signals), synchronization signals (for example, synchronization signal blocks (SSBs)), control information and data information, such as in the form of packets, from one or more other wireless communication devices via various channels including control channels (for example, a physical downlink control channel (PDCCH), physical uplink control channel (PUCCH), or physical sidelink control channel (PSCCH) and data channels (for example, a physical downlink shared channel (PDSCH), physical sidelink shared channel (PSSCH), a physical uplink shared channel (PUSCH)). The other wireless communication devices may include, but are not limited to, a base station 110 as described with reference to FIGS. 1 and 2, a CU 310, DU 330, or RU 340 as described with reference to FIG. 3, a RIS 410 as described with reference to FIGS. 4A, 4B, 4C, and 5, or a network node 404 or 406 as described with reference to FIGS. 4A, 4B, 4C, and 5.

The received information may be passed on to other components of the device 600. The receiver 610 may be an example of aspects of the receive processor 256 described with reference to FIG. 2. The receiver 610 may include a set of radio frequency (RF) chains that are coupled with or otherwise utilize a set of antennas (for example, the set of antennas may be an example of aspects of the antennas 252 described with reference to FIG. 2).

The transmitter 620 may transmit signals generated by the communications manager 605 or other components of the wireless communication device 600. In some examples, the transmitter 620 may be collocated with the receiver 610 in a transceiver. The transmitter 620 may be an example of aspects of the transmit processor 264 described with reference to FIG. 2. The transmitter 620 may be coupled with or otherwise utilize a set of antennas (for example, the set of antennas may be an example of aspects of the antennas 252 described with reference to FIG. 2), which may be antenna elements shared with the receiver 610. In some examples, the transmitter 620 is configured to transmit control information in a PUCCH, PSCCH, or PDCCH and data in a physical uplink shared channel (PUSCH), PSSCH, or PDSCH.

The communications manager 605 may be an example of aspects of the controller/processor 259 described with reference to FIG. 2. The communications manager 605 may include the CSI-RS component 630 and the RIS allocation ratio component 640. In some examples, working in conjunction with the receiver 610, the CSI-RS component 630 may receive, from a first network node of a group of network nodes, a first message configuring a group of CSI-RSs. Each CSI-RS of the group of CSI-RSs may be associated with a RIS-based channel of a group of RIS-based channels. Each RIS-based channel, of the group of RIS-based channels, may be associated with a respective communication link between a respective network node, of the group of network nodes, and the UE via a RIS. Additionally, working in conjunction with the receiver 610, the CSI-RS component 630 may receive, from each network node of the group of network nodes, via the RIS, the respective CSI-RS of the group of CSI-RSs. For example, the the respective CSI-RS may be reflected or refracted by the RIS. Working in conjunction with the CSI-RS component 630, the RIS allocation ratio component estimates, for each RIS-based channel of the group of RIS-based channels, one or more respective channel conditions in accordance with measuring the respective CSI-RS of the group of CSI-RS. Working in conjunction with the transmitter 620, the RIS allocation ratio component transmits, to the first network node, a second message indicating a RIS allocation ratio associated with the estimated one or more respective channel conditions associated with each RIS-based channel of the group of RIS-based channels.

FIG. 7 is a flow diagram illustrating an example process 700 for estimating a RIS allocation ratio, performed, for example, by a user equipment (UE), in accordance with various aspects of the present disclosure. As shown in the example of FIG. 7, at block 702, the process 700 begins by receiving, from a first network node of a group of network nodes, a first message configuring a group of CSI-RSs. Each CSI-RS of the group of CSI-RSs may be associated with a RIS-based channel of a group of RIS-based channels. Each RIS-based channel, of the group of RIS-based channels, may be associated with a respective communication link between a respective network node, of the group of network nodes, and the UE via a RIS. At block 704, the process 700 receives, from each network node of the group of network nodes, via the RIS, the respective CSI-RS of the group of CSI-RSs. For example, the the respective CSI-RS may be reflected or refracted by the RIS. At block 706, the process 700 estimates, for each RIS-based channel of the group of RIS-based channels, one or more respective channel conditions in accordance with measuring the respective CSI-RS of the group of CSI-RS. At block 708, the process 700 transmits, to the first network node, a second message indicating a RIS allocation ratio associated with the estimated one or more respective channel conditions associated with each RIS-based channel of the group of RIS-based channels.

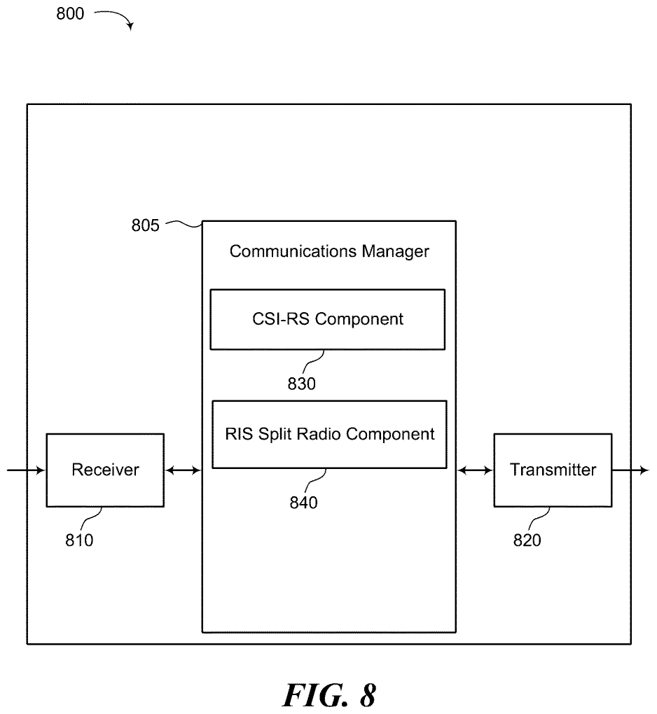

FIG. 8 is a block diagram illustrating an example wireless communication device 800 that supports configuring a RIS in accordance with a RIS allocation ratio estimated at a UE, in accordance with aspects of the present disclosure. The wireless communication device 800 may be an example of a base station 110 as described with reference to FIGS. 1 and 2, a CU 310, DU 330, or RU 340 as described with reference to FIG. 3, or a network node 404 or 406 as described with reference to FIGS. 4A, 4B, 4C, and 5. The wireless communication device 800 may include a receiver 810, a communications manager 805, a CSI-RS component 830, a RIS allocation ratio component 840, and a transmitter 820, which may be in communication with one another (for example, via one or more buses). In some examples, the wireless communication device 800 is configured to perform operations, including operations of the process 900 described below with reference to FIG. 9.

In some examples, the wireless communication device 800 can include a chip, system on chip (SOC), chipset, package, or device that includes at least one processor and at least one modem (for example, a 5G modem or other cellular modem). In some examples, the communications manager 805, or its sub-components, may be separate and distinct components. In some examples, at least some components of the communications manager 805 are implemented at least in part as software stored in a memory. For example, portions of one or more of the components of the communications manager 805 can be implemented as non-transitory code executable by the processor to perform the functions or operations of the respective component.

The receiver 810 may receive one or more reference signals (for example, periodically configured CSI-RSs, aperiodically configured CSI-RSs, or multi-beam-specific reference signals), synchronization signals (for example, synchronization signal blocks (SSBs)), control information, and/or data information, such as in the form of packets, from one or more other wireless communication devices via various channels including control channels (for example, a PUCCH or a PSCCH) and data channels (for example, a PUSCH or a PSSCH). The other wireless communication devices may include, but are not limited to, a UE 120, described with reference to FIGS. 1, 2, 3, 4A 4B, 4C, and 5.

The received information may be passed on to other components of the wireless communication device 800. The receiver 810 may be an example of aspects of the receive processor 270 described with reference to FIG. 2. The receiver 810 may include a set of radio frequency (RF) chains that are coupled with or otherwise utilize a set of antennas (for example, the set of antennas may be an example of aspects of the antennas 234 described with reference to FIG. 2).

The transmitter 820 may transmit signals generated by the communications manager 805 or other components of the wireless communication device 800. In some examples, the transmitter 820 may be collocated with the receiver 810 in a transceiver. The transmitter 820 may be an example of aspects of the transmit processor 216 described with reference to FIG. 2. The transmitter 820 may be coupled with or otherwise utilize a set of antennas (for example, the set of antennas may be an example of aspects of the antennas 252), which may be antenna elements shared with the receiver 810. In some examples, the transmitter 820 is configured to transmit control information in a PDCCH or a PSCCH and data in a PDSCH or PSSCH.

The communications manager 805 may be an example of aspects of the controller/processor 275 described with reference to FIG. 2. The communications manager 805 includes the CSI-RS component 830 and the RIS allocation ratio component 840. In some examples, working in conjunction with the transmitter 820, the CSI-RS component 830 transmits a first message configuring a group of CSI-RSs at a UE. Each CSI-RS of the group of CSI-RSs may be associated with a RIS-based channel of a group of RIS-based channels. Each RIS-based channel, may be associated with a respective communication link between a respective network node, of the group of network nodes, and the UE via a RIS. Additionally, working in conjunction with the transmitter 820, the CSI-RS component 830 transmits a second message configuring the group of CSI-RSs and corresponding incident beams at the RIS, and also transmits the respective CSI-RS of the group of CSI-RSs. Working in conjunction with the receiver 810, the RIS allocation ratio component 840 receives, from the UE in accordance with transmitting the respective CSI-RS, a third message indicating a RIS allocation ratio associated with one or more respective channel conditions associated with each RIS-based channel of the group of RIS-based channels. Additionally, working in conjunction with the transmitter 820, the RIS allocation ratio component 840 transmits a fourth message configuring the RIS in accordance with the RIS allocation ratio.

FIG. 9 is a flow diagram illustrating an example process 900 performed by a network node, in accordance with various aspects of the present disclosure. The process 900 may be performed by a network node, such as a base station 110 as described with reference to FIGS. 1 and 2, a CU 310, DU 330, or RU 340 as described with reference to FIG. 3, a network node 404 or 406 as described with reference to FIGS. 4A, 4B, 4C, and 5, or a wireless communication device 800 as described with reference to FIG. 8. The process 900 begins at block 902 by transmitting a first message configuring a group of CSI-RSs at a UE. Each CSI-RS of the group of CSI-RSs may be associated with a RIS-based channel of a group of RIS-based channels. Each RIS-based channel, may be associated with a respective communication link between a respective network node, of the group of network nodes, and the UE via a RIS. At block 904, the process 900 transmits a second message configuring the group of CSI-RSs and corresponding incident beams at the RIS. At block 906, the process 900 transmits the respective CSI-RS of the group of CSI-RSs. At block 908, the process 900 receives, from the UE in accordance with transmitting the respective CSI-RS, a third message indicating a RIS allocation ratio associated with one or more respective channel conditions associated with each RIS-based channel of the group of RIS-based channels. At block 910, the process 900 transmits a fourth message configuring the RIS in accordance with the RIS allocation ratio.

Implementation examples are described in the following numbered clauses:
Clause 1. A method for wireless communication at a UE, comprising: receiving, from a first network node of a group of network nodes, a first message configuring a group of CSI-RSs, each CSI-RS of the group of CSI-RSs being associated with a RIS-based channel of a group of RIS-based channels, each RIS-based channel, of the group of RIS-based channels, being associated with a respective communication link between a respective network node, of the group of network nodes, and the UE via a RIS; receiving, from each network node of the group of network nodes, via a reflection from the RIS, the respective CSI-RS of the group of CSI-RSs; estimating, for each RIS-based channel of the group of RIS-based channels, one or more respective channel conditions in accordance with measuring the respective CSI-RS of the group of CSI-RS; and transmitting, to the first network node, a second message indicating a RIS allocation ratio associated with the estimated one or more respective channel conditions associated with each RIS-based channel of the group of RIS-based channels.
Clause 2. The method of Clause 1, wherein the RIS allocation ratio is associated with a maximum total channel capacity that is a collective sum of respective channel capacities of the group of RIS-based channels.
Clause 3. The method of any one of Clauses 1-2, further comprising determining, for each RIS-based channel of the group of RIS-based channels, the respective channel capacity in accordance with a respective first channel matrix and the RIS allocation ratio.
Clause 4. The method of Clause 3, further comprising determining, for each RIS-based channel of the group of RIS-based channels, the respective first channel matrix in accordance with a respective group of cascading channel matrices associated with the one or more respective channel conditions of the RIS-based channel and a respective reflection coefficient matrix.
Clause 5. The method of Clause 3, further comprising: generating, for each RIS-based channel of the group of RIS-based channels, a respective first group of cascading channel matrices by concatenating a respective second channel matrix, associated with a respective direct link between the respective network node associated with the RIS-based channel and the UE, and a respective second group of cascading channel matrices associated with the one or more respective channel conditions of the RIS-based channel; and determining, for each RIS-based channel of the group of RIS-based channels, the respective first channel matrix based on the respective first group of cascading channel matrices and a respective reflection coefficient matrix.
Clause 6. The method of any one of Clauses 1-5, wherein each CSI-RS of the group of CSI-RSs is associated with a different respective time occasion.
Clause 7. The method of any one of Clauses 1-6, wherein: the RIS allocation ratio indicates a respective amount of meta-elements, of a group of meta-elements associated with the RIS, allocated to each network node of the group of network nodes; and each meta-element of the group of meta-elements is associated with an adjustment to one or both of a phase or amplitude of a signal.
Clause 8. The method of any one of Clauses 1-7, further comprising receiving, from the first network node, a third message indicating a set of candidate RIS allocation ratios supported by the RIS, wherein the RIS allocation ratio is one candidate RIS allocation ratio of the set of candidate RIS allocation ratios.
Clause 9. A method for wireless communication at a first network node of a group of network node, comprising: transmitting a first message configuring a group of CSI-RSs at a UE, each CSI-RS of the group of CSI-RSs being associated with a RIS-based channel of a group of RIS-based channels, each RIS-based channel, of the group of RIS-based channels, being associated with a respective communication link between a respective network node, of the group of network nodes, and the UE via a RIS; transmitting a second message configuring the group of CSI-RSs and corresponding incident beams at the RIS; transmitting the respective CSI-RS of the group of CSI-RSs; receiving, from the UE in accordance with transmitting the respective CSI-RS, a third message indicating a RIS allocation ratio associated with one or more respective channel conditions associated with each RIS-based channel of the group of RIS-based channels; and transmitting a fourth message configuring the RIS in accordance with the RIS allocation ratio.
Clause 10. The method of Clause 9, wherein the RIS allocation ratio is associated with a maximum total channel capacity that is a collective sum of respective channel capacities of the group of RIS-based channels.
Clause 11. The method of any one of Clauses 9-10, wherein, for each RIS-based channel of the group of RIS-based channels, the respective channel capacity is associated with a respective first channel matrix associated and the RIS allocation ratio.
Clause 12. The method of Clause 11, wherein, for each RIS-based channel of the group of RIS-based channels, the respective first channel matrix is associated with a respective group of cascading channel matrices associated with the one or more respective channel conditions of the RIS-based channel and a respective reflection coefficient matrix.
Clause 13. The method of any one of Clauses 9-12, wherein each CSI-RS of the group of CSI-RSs is associated with a different respective time occasion.
Clause 14. The method of any one of Clauses 9-13, wherein: the RIS allocation ratio indicates a respective amount of meta-elements, of a group of meta-elements associated with the RIS, allocated to each network node of the group of network nodes; and each meta-element of the group of meta-elements is associated with an adjustment to one or both of a phase or amplitude of a signal.
Clause 15. The method of any one of Clauses 9-14, further comprising: receiving, from the RIS, a fifth message indicating a set of candidate RIS allocation ratios supported by the RIS; and transmitting, to the UE, a third message indicating a set of candidate RIS allocation ratios supported by the RIS.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (for example, a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (for example, related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

1. A method for wireless communication at a user equipment (UE), comprising:
receiving, from a first network node of a group of network nodes, a first message configuring a group of channel state information (CSI) reference signals (RSs) (CSI-RSs), each CSI-RS of the group of CSI-RSs being associated with a reconfigurable intelligent surface (RIS)-based channel of a group of RIS-based channels, each RIS-based channel, of the group of RIS-based channels, being associated with a respective communication link between a respective network node, of the group of network nodes, and the UE via a RIS;
receiving, from each network node of the group of network nodes, via the RIS, the respective CSI-RS of the group of CSI-RSs;
estimating, for each RIS-based channel of the group of RIS-based channels, one or more respective channel conditions in accordance with measuring the respective CSI-RS of the group of CSI-RS; and
transmitting, to the first network node, a second message indicating a RIS allocation ratio associated with the estimated one or more respective channel conditions associated with each RIS-based channel of the group of RIS-based channels.

2. The method of claim 1, wherein the RIS allocation ratio is associated with a maximum total channel capacity that is a collective sum of respective channel capacities of the group of RIS-based channels.

3-5. (canceled)

6. The method of claim 1, wherein each CSI-RS of the group of CSI-RSs is associated with a different respective time occasion.

7. The method of claim 1, wherein:
the RIS allocation ratio indicates a respective amount of meta-elements, of a group of meta-elements associated with the RIS, allocated to each network node of the group of network nodes; and
each meta-element of the group of meta-elements is associated with an adjustment to one or both of a phase or amplitude of a signal.

8. The method of claim 1, further comprising receiving, from the first network node, a third message indicating a set of candidate RIS allocation ratios supported by the RIS, wherein the RIS allocation ratio is one candidate RIS allocation ratio of the set of candidate RIS allocation ratios.

9. An apparatus for wireless communications at a user equipment (UE), comprising:
a processor; and
a memory coupled with the processor and storing instructions operable, when executed by the processor, to cause the apparatus to:
receive, from a first network node of a group of network nodes, a first message configuring a group of channel state information (CSI) reference signals (RSs) (CSI-RSs), each CSI-RS of the group of CSI-RSs being associated with a reconfigurable intelligent surface (RIS)-based channel of a group of RIS-based channels, each RIS-based channel, of the group of RIS-based channels, being associated with a respective communication link between a respective network node, of the group of network nodes, and the UE via a RIS;
receive, from each network node of the group of network nodes, via the RIS, the respective CSI-RS of the group of CSI-RSs;
estimate, for each RIS-based channel of the group of RIS-based channels, one or more respective channel conditions in accordance with measuring the respective CSI-RS of the group of CSI-RS; and
transmit, to the first network node, a second message indicating a RIS allocation ratio associated with the estimated one or more respective channel conditions associated with each RIS-based channel of the group of RIS-based channels.

10. The apparatus of claim 9, wherein the RIS allocation ratio is associated with a maximum total channel capacity that is a collective sum of respective channel capacities of the group of RIS-based channels.

11. The apparatus of claim 10, wherein execution of the instructions further cause the apparatus to determine, for each RIS-based channel of the group of RIS-based channels, the respective channel capacity in accordance with a respective first channel matrix and the RIS allocation ratio.

12. The apparatus of claim 11, wherein execution of the instructions further cause the apparatus to determine, for each RIS-based channel of the group of RIS-based channels, the respective first channel matrix in accordance with a respective group of cascading channel matrices associated with the one or more respective channel conditions of the RIS-based channel and a respective reflection coefficient matrix.

13. The apparatus of claim 11, wherein execution of the instructions further cause the apparatus to:
generate, for each RIS-based channel of the group of RIS-based channels, a respective first group of cascading channel matrices by concatenating a respective second channel matrix, associated with a respective direct link between the respective network node associated with the RIS-based channel and the UE, and a respective second group of cascading channel matrices associated with the one or more respective channel conditions of the RIS-based channel; and
determine, for each RIS-based channel of the group of RIS-based channels, the respective first channel matrix based on the respective first group of cascading channel matrices and a respective reflection coefficient matrix.

14. The apparatus of claim 9, wherein each CSI-RS of the group of CSI-RSs is associated with a different respective time occasion.

15. The apparatus of claim 9, wherein:
the RIS allocation ratio indicates a respective amount of meta-elements, of a group of meta-elements associated with the RIS, allocated to each network node of the group of network nodes; and
each meta-element of the group of meta-elements is associated with an adjustment to one or both of a phase or amplitude of a signal.

16. The apparatus of claim 9, wherein:
execution of the instructions further cause the apparatus to receive, from the first network node, a third message indicating a set of candidate RIS allocation ratios supported by the RIS; and
the RIS allocation ratio is one candidate RIS allocation ratio of the set of candidate RIS allocation ratios.

17-23. (canceled)

24. An apparatus for wireless communications at a network node, comprising:
a processor; and
a memory coupled with the processor and storing instructions operable, when executed by the processor, to cause the apparatus to:
transmit a first message configuring a group of channel state information (CSI) reference signals (RSS) (CSI-RSs) at a user equipment (UE), each CSI-RS of the group of CSI-RSs being associated with a reconfigurable intelligent surface (RIS)-based channel of a group of RIS-based channels, each RIS-based channel, of the group of RIS-based channels, being associated with a respective communication link between a respective network node, of the group of network nodes, and the UE via a RIS;
transmit a second message configuring the group of CSI-RSs and corresponding incident beams at the RIS;
transmit the respective CSI-RS of the group of CSI-RSs;
receive, from the UE in accordance with transmitting the respective CSI-RS, a third message indicating a RIS allocation ratio associated with one or more respective channel conditions associated with each RIS-based channel of the group of RIS-based channels; and
transmit a fourth message configuring the RIS in accordance with the RIS allocation ratio.

25. The apparatus of claim 24, wherein the RIS allocation ratio is associated with a maximum total channel capacity that is a collective sum of respective channel capacities of the group of RIS-based channels.

26. The apparatus of claim 25, wherein, for each RIS-based channel of the group of RIS-based channels, the respective channel capacity is associated with a respective first channel matrix associated and the RIS allocation ratio.

27. The apparatus of claim 26, wherein, for each RIS-based channel of the group of RIS-based channels, the respective first channel matrix is associated with a respective group of cascading channel matrices associated with the one or more respective channel conditions of the RIS-based channel and a respective reflection coefficient matrix.

28. The apparatus of claim 24, wherein each CSI-RS of the group of CSI-RSs is associated with a different respective time occasion.

29. The apparatus of claim 24, wherein:
the RIS allocation ratio indicates a respective amount of meta-elements, of a group of meta-elements associated with the RIS, allocated to each network node of the group of network nodes; and
each meta-element of the group of meta-elements is associated with an adjustment to one or both of a phase or amplitude of a signal.

30. The apparatus of claim 24, wherein execution of the instructions further cause the apparatus to:
receive, from the RIS, a fifth message indicating a set of candidate RIS allocation ratios supported by the RIS; and
transmit, to the UE, a third message indicating a set of candidate RIS allocation ratios supported by the RIS.
